(19) United States
(12) Patent Application Publication
(10) Pub. No.: US 2007/0014111 A1
(43) Pub. Date: Jan. 18, 2007

(54) LIGHT DIFFUSING ASSEMBLY

(75) Inventors: Mao-Song Lee, Hsin Chu City (TW); Hsi-Hsin Shih, Taichung City (TW); Shih-Kai Cheng, Yi Lan City (TW)

Correspondence Address: OSTROLENK FABER GERB & SOFFEN, 1180 AVENUE OF THE AMERICAS, NEW YORK, NY, 100368403, US

(73) Assignee: CHI LIN TECHNOLOGY CO., LTD., Tainan County (TW)

(21) Appl. No.: 11/536,493

(22) Filed: Sep. 28, 2006

(30) Foreign Application Priority Data
Jun. 20, 2005 (TW) 094120442

(51) Int. Cl. F21V 5/00

(52) U.S. Cl. 362/246; 362/355

(57) ABSTRACT

A light diffusing assembly includes: a diffuser plate exhibiting a light scattering effect and having a light-emerging surface; and a brightness-enhancing film exhibiting a light concentrating effect and formed directly on the light-emerging surface of the diffuser plate. The brightness-enhancing film has a roughened surface opposite to the light-emerging surface of the diffuser plate.

### BACKGROUND OF THE INVENTION

1. Field of the Invention

This invention relates to a light diffusing assembly, more particularly to a light diffusing assembly having a brightness-enhancing film formed directly on a diffuser plate.

2. Description of the Related Art

A backlight module is one of the key components of a liquid crystal display, and serves to provide a uniform light source for enabling the display of an image on a liquid crystal panel. Based on the disposition of the light source, backlight modules can be classified into a bottom lighting type and a side lighting type.

FIGS. 1 and 2 illustrate a conventional light diffusing assembly 1 for a bottom lighting type backlight module. The conventional light diffusing assembly 1 includes a reflective base 11 having an open end, a diffuser plate 13 mounted on the open end of the reflective base 11 so as to define an accommodating space therebetween, a plurality of light emitting units 12, such as a cold cathode fluorescent lamp (CCFL) or an LED light source, mounted in the accommodating space, and a brightness-enhancing sheet 14 disposed above and spaced apart from the diffuser plate 13 by a gap 15. The light emitted from the light emitting units 12 is reflected by the reflective base 11 toward the diffuser plate 13, is subsequently scattered upon passing through the diffuser plate 13, and then passes through the gap 15 and the brightness-enhancing sheet 14 so as to undergo a series of reflection, refraction, scattering, and concentration before being projected onto a liquid crystal panel 2.

However, in order to avoid dust contamination, manufacture of the conventional light diffusing assembly 1 is required to be performed in a clean room, which results in higher production costs. In addition, the presence of the gap 15 undesirably increases the overall thickness of the light diffusing assembly 1. Moreover, the presence of air in the gap 15 between the diffuser plate 13 and the brightness-enhancing film 14 reduces the transmittance of the assembly of the diffuser plate 13 and the brightness-enhancing sheet 14.

### SUMMARY OF THE INVENTION

Therefore, the object of the present invention is to provide a light diffusing assembly that can overcome the aforesaid drawbacks of the prior art.

According to this invention, there is provided a light diffusing assembly that comprises: a diffuser plate exhibiting a light scattering effect and having a light-emerging surface; and a brightness-enhancing film exhibiting a light concentrating effect and formed directly on the light-emerging surface of the diffuser plate.

### BRIEF DESCRIPTION OF THE DRAWING

Other features and advantages of the present invention will become apparent in the following detailed description of the preferred embodiment of this invention, with reference to the accompanying drawing, in which:

FIG. 1 is a schematic partly sectional view of a conventional light diffusing assembly for a backlight module of a liquid crystal display;

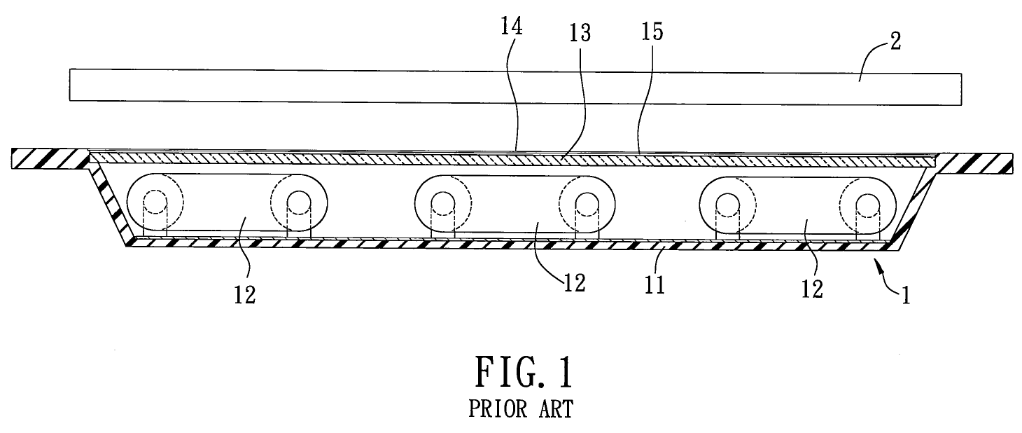

FIG. 2 is a fragmentary sectional view of the conventional light diffusing assembly;

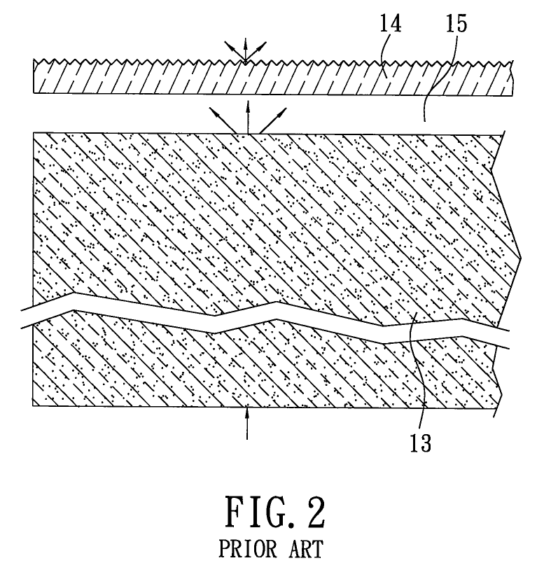

FIG. 3 is a schematic partly sectional view of the preferred embodiment of a light diffusing assembly for a backlight module of a liquid crystal display according to this invention; and

FIG. 4 is a fragmentary sectional view of the preferred embodiment.

### DETAILED DESCRIPTION OF THE PREFERRED EMBODIMENT

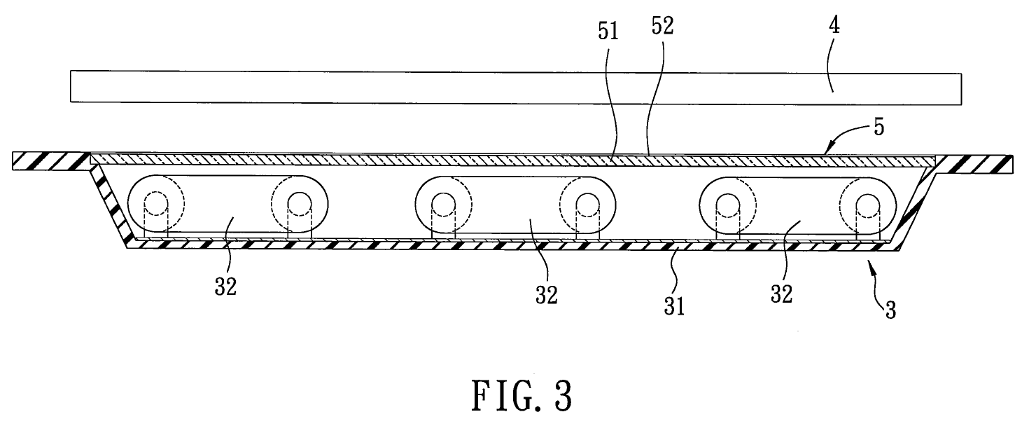

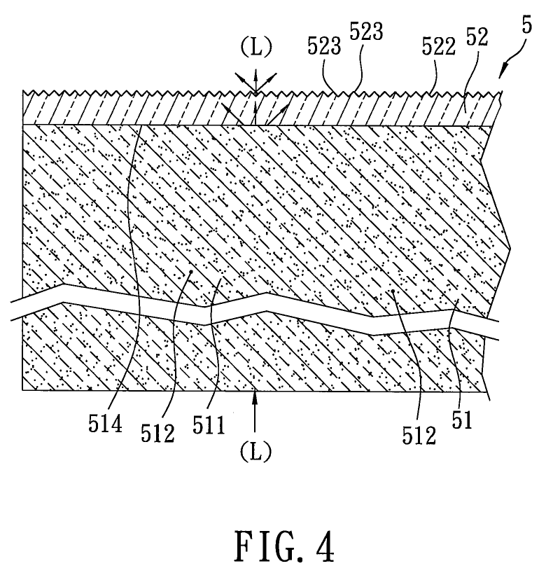

FIGS. 3 and 4 illustrate the preferred embodiment of a light diffusing assembly 5 for a backlight module 3, which serves to provide a uniform light source to be projected onto a liquid crystal panel 4 of a liquid crystal display, according to this invention.

The backlight module 3 further includes a reflective base 31 and a plurality of light emitting units 32, each of which can be a CCFL or an LED light source. The configuration of the CCFL light source can be a U-shaped, L-shaped, or W-shaped tube, or a planar two-D structure.

The light diffusing assembly 5 includes: a diffuser plate 51 exhibiting a light scattering effect and having a light-emerging surface 514; and a brightness-enhancing film 52 exhibiting a light concentrating effect and formed directly on the light-emerging surface 514 of the diffuser plate 51.

The diffuser plate 51 includes a resinous matrix 511 and a plurality of diffusing particles 512 dispersed in the resinous matrix 511 and capable of scattering light passing therethrough. Preferably, when the resinous matrix 511 is made from acrylic, the diffusing particles 512 are made from polycarbonate, and when the resinous matrix 511 is made from polystyrene, the diffusing particles 512 are made from acrylic.

The brightness-enhancing film 52 has a roughened surface 522 opposite to the light-emerging surface 514 of the diffuser plate 51. The roughened surface 522 of the brightness-enhancing film 52 functions to enhance light extraction efficiency of the diffuser plate 51 by concentrating and collimating the light passing therethrough. In this embodiment, the roughened surface 522 of the brightness-enhancing film 52 is formed with a plurality of prism-shaped protrusions 522. Alternatively, the protrusions 522 can be a pyramid, rectangular, or a dome in shape. Preferably, the brightness-enhancing film 52 is made from a material selected from the group consisting of epoxy and acrylic resin. As best shown in FIG. 4, the light beam (L) passes through the diffuser plate 51 and is scattered into a relatively wide angle when emerging from the light-emerging surface 514 of the diffuser plate 51. The angle of the light beam (L) emerging from the diffuser plate 51 is then reduced when passing through the brightness-enhancing film 52, thereby enhancing the brightness of the light beam (L) as well as correcting the orientation of the light beam toward the liquid crystal panel 4.

The light diffusing assembly 5 can be made in a conventional manner by preparing the diffuser plate 51, coating a curable resin layer on the light-emerging surface 514 of the diffuser plate 51, press-molding the curable resin layer to form a plurality of protrusions corresponding to the protrusions 523, followed by curing the protrusions 523 to form the brightness-enhancing film 52 using a UV light source. The press-molding operation can be conducted using a roller provided with a mold thereon. The mold is formed with protrusions and recesses that have a structure corresponding to that of the protrusions 523 of the brightness-enhancing film 52.

The merits of the light diffusing assembly 5 of this invention will become apparent with reference to test results carried out in a conventional test method. The test results show that the light diffusing assembly 5 of this invention has a light transmittance of 57% as compared to the aforesaid conventional light diffusing assembly which has a light transmittance of 34%.

By forming the brightness-enhancing film 52 directly on the diffuser plate 51 of the light diffusing assembly 5 of this invention, the aforesaid drawbacks associated with the prior art can be eliminated.

While the present invention has been described in connection with what is considered the most practical and preferred embodiment, it is understood that this invention is not limited to the disclosed embodiment but is intended to cover various arrangements included within the spirit and scope of the broadest interpretation and equivalent arrangements.

What is claimed is:

1. A light diffusing assembly comprising:
a diffuser plate exhibiting alight scattering effect and having a light-emerging surface; and
a brightness-enhancing film exhibiting a light concentrating effect and formed directly on said light-emerging surface of said diffuser plate.

2. The light diffusing assembly of claim 1, wherein said brightness-enhancing film has a roughened surface opposite to said light-emerging surface of said diffuser plate.

3. The light diffusing assembly of claim 2, wherein said roughened surface of said brightness-enhancing film is formed with a plurality of prism-shaped protrusions.

4. The light diffusing assembly of claim 1, wherein said diffuser plate includes a resinous matrix and a plurality of diffusing particles dispersed in said resinous matrix, said resinous matrix being made from acrylic and said diffusing particles being made from polycarbonate.

5. The light diffusing assembly of claim 1, wherein said diffuser plate includes a resinous matrix and a plurality of diffusing particles dispersed in said resinous matrix, said resinous matrix being made from polystyrene and said diffusing particles being made from acrylic.

6. The light diffusing assembly of claim 1, wherein said brightness-enhancing film is made from epoxy.

7. The light diffusing assembly of claim 1, wherein said brightness-enhancing film is made from acrylic resin.
